(19) United States
(12) Patent Application Publication
(10) Pub. No.: US 2015/0264047 A1
(43) Pub. Date: Sep. 17, 2015

(54) METHOD AND SYSTEM FOR PROVIDING SECURE COMMUNICATION BETWEEN MULTIPLE OPERATING SYSTEMS IN A COMMUNICATION DEVICE

(71) Applicant: Agreeya Mobility, Inc., Mountain View, CA (US)

(72) Inventors: Gaurav Sujit Roy, Pune (IN); Ankush Tiwari, Pune (IN); Pankaj Thapa, California, CA (US)

(21) Appl. No.: 14/656,977

(22) Filed: Mar. 13, 2015

Related U.S. Application Data
(63) Continuation of application No. 61/951,837, filed on Mar. 12, 2014.

(51) Int. Cl. H04L 29/06

(52) U.S. Cl. CPC H04L 63/0869; H04L 63/0442

(57) ABSTRACT

Present disclosure provides a method and system for providing a secure communication between multiple operating systems in a communication device. A primary operating system in the communication device is loaded. An authentication check of one or more secondary operating systems in the communication device is performed through the primary operating system, wherein the one or more secondary operating systems are authenticated based on rule assignation. A secure communication is enables between the one or more secondary operating systems after the authentication.

### PRIORITY DETAILS

The present application is based on, and claims priority from, U.S. Application No. 61/951,837, filed on 12 Mar. 2014, the disclosure of which is hereby incorporated by reference herein.

### TECHNICAL FIELD

This embodiment relates to mobile computing, and more particularly to a mechanism for mobile security, and providing multiple personas on a mobile device.

### BACKGROUND

With the evolution of mobile computing, users use mobile device not just for communication, but also for organizing and planning their work, and private life. The users can store personal data on their mobile devices. The personal information can include for example, but not limited to, bank related transactions, photos, music, organizer, email and the like. User may also a store a lot of enterprise related data on the mobile device.

The information on the mobile device is susceptible to variety of security threats, and attack. The storing of work related data on the mobile device and their security can be a big concern for enterprises. An attacker generally targets data like credit card number, authentication information, identity information, work related information and the like. The attacker may attempt to steal the mobile device user's identity and commit crimes using the stolen identity. The usage of internet on mobile devices makes mobile device susceptible to security threat like a malware attack. The malware attack may infect the mobile device, access the user's personal information and spread to other devices in proximity using the mobile device connectivity. An attacker may try to access user's personal information through the communication network utilized by the user's mobile devices. The integrity of the operating system in the mobile device may also be comprised by an attacker.

Different systems and methods are proposed for, reducing security threat and attack, on data stored in mobile device. In one mechanism, to protect passwords and username, anti phasing data is added to a password acceptance process. Consider an example, where the anti-phasing data contains an image and text related to each other. An attacker who can replicate the password acceptance screen can easily locate the anti-phishing data, replicate the anti-phishing data, and create a screen with anti-phishing data. In one mechanism, when the integrity of the mobile device is comprised, the secure boot does not boot the operating system. Although the attack on the mobile device is stopped by not loading the operating system, the user loses access to basic functions like making calls, and sending messages. In another mechanism, a mobile device user can have multiple operating systems running. A hypervisor may used for creating the multiple operating systems. Consider an example where, a first operating system may include data related to user's personal life, and second operating system may include sensitive data related to banking and enterprise. The second operating system, which includes secure data related to banking and enterprise, would install applications with greater scrutiny and control. There is no data communication between the first and the second operating system. Although the user can access both the operating systems simultaneously, he cannot transfer or sync data between the first and second communication system. In another mechanism, multiple user profiles can be allowed to run on a single operating system. Consider an example where, a first user profile is associated with personal data and a second user profile is associated with secure data like enterprise data, banking data and the like. Data stored in the two profiles will be separate and cannot be shared between the first and second user profile. In another mechanism, data can be synced between the first user profile and secondary user profile. This syncing of data may allow malware or any other attacker to gain access to secure information like personal information and enterpriser related data.

### SUMMARY

The present disclosure provided a method for providing a secure communication between multiple operating systems in a communication device. The method comprises loading a primary operating system in the communication device, performing through the primary operating system, an authentication check of one or more secondary operating systems in the communication device, wherein the one or more secondary operating systems are authenticated based on rule assignation and enabling a secure communication between the one or more secondary operating systems after the authentication.

The present disclosure in an embodiment also provides a system providing a secure communication between multiple operators in a communication device. The system comprises a processor and a memory coupled to the processor. The memory stores a plurality of modules to be executed by the processor, wherein the plurality of modules are configured to load a primary operating system, performing through the primary operating system, an authentication check of one or more secondary operating systems in the communication device, wherein the one or more secondary operating systems are authenticated based on rule assignation and enabling a secure communication between the one or more secondary operating systems after the authentication.

### BRIEF DESCRIPTION OF FIGURES

This embodiment is illustrated in the accompanying drawings, through out which like reference letters indicate corresponding parts in the various figures. The embodiments herein will be better understood from the following description with reference to the drawings, in which:

FIG. 1 is a diagram that illustrates a network implementation of communication device, according to embodiments as disclosed herein;

FIG. 2 is a diagram that illustrates details of modules in the communication device, according to embodiments as disclosed herein;

FIG. 3 is a diagram that illustrates a high level architecture of operating systems in a mobile device, according to embodiments as disclosed herein;

FIG. 4 is a diagram that illustrates components loaded in the memory of the secured operating system, according to embodiments as disclosed herein;

FIG. 5 is a flow chart that illustrates a method for authenticating operating systems, according to embodiments as disclosed herein;

FIG. 6 is a flow chart that illustrates a method for secure communication between the personal operating system and the protected operating system using a secure third operating system, according to embodiments as disclosed herein;

FIG. 7 is a diagram that illustrates a high level architecture of a system in which a read-only secure operating system 106 is embodied, according to embodiments as disclosed herein;

FIG. 8 is a flow chart that illustrates a method for setup of anti-phishing data during password setup process, according to embodiments as disclosed herein;

FIG. 9 is a flow chart that illustrates a method for retrieving anti-phishing data from the secure operating system during a password acceptance process, according to embodiments as disclosed herein;

FIG. 10 is a diagram that illustrates a high level architecture of a secure communication bridge between two different personas, according to embodiments as disclosed herein;

FIG. 11 is an exemplary diagram illustrating multiple users having multiple personas on a mobile device, according to embodiments as disclosed herein;

FIG. 12 is a diagram that illustrates the secure bridge, according to embodiments as disclosed herein;

FIGS. 13 A and 13B shows an example of a primary persona and an enterprise persona on a mobile device, according to embodiments as disclosed herein;

FIG. 14 is an exemplary flow chart that illustrates a method for contact sync from a primary persona to a secondary persona using a secure bridge, according to embodiments as disclosed herein;

FIG. 15 is an exemplary flow chart that illustrates a method for calendar sync from a primary persona to a secondary persona using a secure bridge, according to embodiments as disclosed herein;

FIG. 16 is an exemplary flow chart that illustrates a method for calendar sync from a secondary persona to a primary persona using a secure bridge, according to embodiments as disclosed herein;

FIG. 17 is an exemplary flow chart that illustrates a method for settings sync between a secondary persona and a primary persona, according to embodiments as disclosed herein;

FIG. 18 is a flow chart that illustrates a method for classifying calls and incoming messages to a persona, according to embodiments as disclosed herein;

FIG. 19 is a flow chart that illustrates a method for generating an integrity value for a operating system in the mobile device during the booting process, according to embodiments as disclosed herein;

FIG. 20 is a flow chart that illustrates a method for creating an encrypted partition key for the secondary persona, according to embodiments as disclosed-herein;

FIG. 21 is a flow chart that illustrates a method for loading the secondary persona, according to embodiments as disclosed herein;

FIG. 22 is a diagram that illustrates a high level architecture of components required for loading of a mobile operating system, according to embodiments as disclosed herein; and

FIG. 23 is a flow chart that illustrates a method for secure loading of the mobile operating system from a removable media, according to embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to describing the present embodiment detail, it is useful to provide definitions for key terms and concepts used herein. Unless defined otherwise, all technical and scientific terms used herein have the same meaning as commonly understood by one of ordinary skill in the art.

The term “mobile device” used in this disclosure refers to any mobile handheld computing device.

The term “operating system” or “mobile operating system” used in this disclosure refers to an operating system used to operate a mobile device with computing ability.

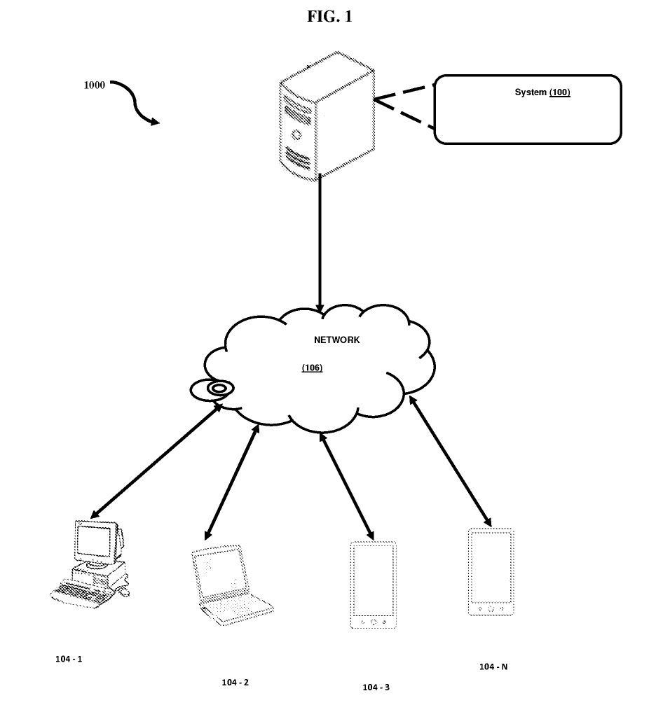

The embodiments herein achieve a system and method for providing multiple personas and improved security on mobile device improved security. Referring now to the drawings, and more particularly to FIGS. 1 through 23, where similar reference characters denote corresponding features consistently throughout the figures, there are shown preferred embodiments.

In an embodiment, a system and method is disclosed for a secure rule based communication between two mobile operating systems on a mobile device using a secured operating system.

The principal object of this embodiment is to provide a system and method for mobile security.

Another object of the embodiment is to provide a secure operating system, communicating between plurality operating systems running on a mobile device.

A further object of the embodiment is to create, and save anti-phishing data, in a read only secure operating system.

A further object of the embodiment is to provide a mechanism for enabling one user to have multiple user personas on a mobile operating system.

A further object of the embodiment is to provide a mechanism for data transfer between two different personas of a user.

A further object of the embodiment is to provide a mechanism for selectively disabling enterprise feature and access to protected data, when the integrity of the mobile operating system is compromised

A further objective of the embodiment is to provide a mechanism for loading a secured operating system from a removable media.

Present disclosure provide a method and system for a secure communication between multiple operating systems in a communication device. From multiple operating systems, a primary operating system is loaded in the communication device. The primary operating system may be termed as a secure operating system. The primary operating system performs an authentication check of one or more operating systems loaded in the communication device. The one or more secondary operating systems comprises a personal operating system and a protected operating system. The primary operating system authenticates the one or more secondary operating systems in accordance with an authentication value and by assigning a rule. After the one or more secondary operating systems are authenticated, the primary operating system enables a secure communication between the one or more secondary operating systems.

Referring to FIG. 1, a network implementation 1000 of the system 100 is shown. Although the present subject matter is explained considering that the system 100 may also be implemented as an application (to execute a set of instructions) on a server, it may be understood that the system 100 may also be implemented as a variety of computing systems, such as a laptop computer, a desktop computer, a notebook, a workstation, a server, a network server, an electronic device and the like. In one implementation, the system 100 may be implemented in a cloud-based environment. It may be understood that the system 100 may be accessed by multiple users through one or more user devices 104-1, 104-2 . . . 104-N, collectively referred to as user 104 hereinafter, or applications residing on the user devices 104 (communication device or mobile device). Examples of the user devices 104 may include, but are not limited to, a portable computer, a personal digital assistant, a handheld device, and a workstation. The user devices 104 are communicatively coupled to the system 100 through a network 106.

In one implementation, the network 106 may be a wireless network, a wired network or a combination thereof. The network 106 can be implemented as one of the different types of networks, such as intranet, local area network (LAN), wide area network (WAN), the internet, and the like.

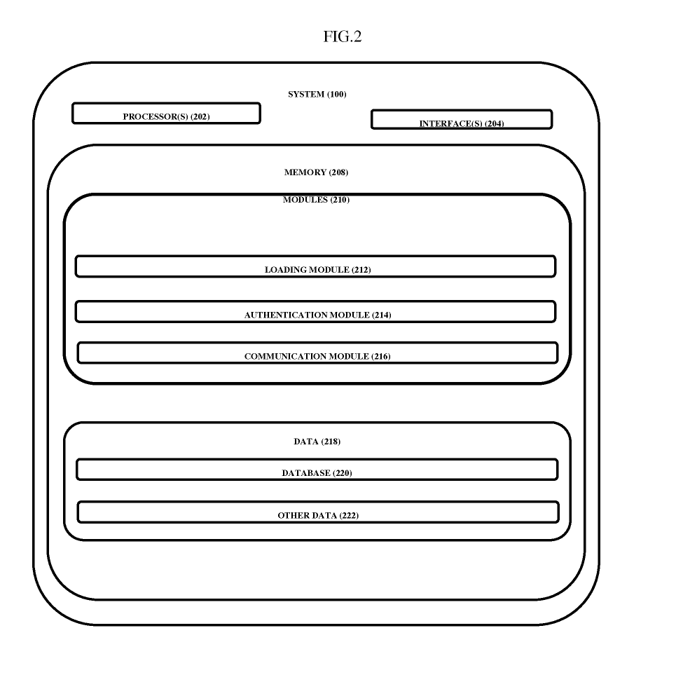

Referring to FIG. 2, the system 100 is illustrated in accordance with an embodiment of the present subject matter. In one embodiment, the system 100 may include at least one processor 202, an input/output (I/O) interface 204 (herein a configurable user interface), a memory 208. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 208.

The I/O interface 204 may include a variety of software and hardware interfaces, for example, a web interface, a graphical user interface, and the like. The I/O interface 204 may allow the system 100 to interact with a user directly or through the client devices 104. Further, the I/O interface 204 may enable the communication device 100 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The modules 210 include routines, programs, objects, components, data structures, etc., which perform particular tasks, functions or implement particular abstract data types. In one implementation, the modules 210 may include a loading module 212, an authentication module 214 and a communication module 216. The modules 210 may include programs or coded instructions that supplement applications and functions of the system 100.

The data 218, amongst other things, serves as a repository for storing data processed, received, and generated by one or more of the modules 210. The data 218 may also include a database 220, and other data 224. The other data 224 may include data generated as a result of the execution of one or more modules 210.

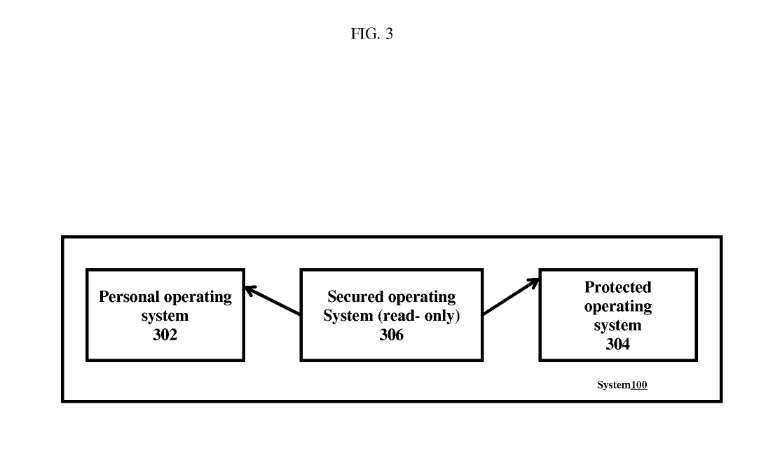

FIG. 3 is a diagram that illustrates a high level architecture of the primary operating system and the one or more secondary operating systems in the communication device 100, according to embodiments as disclosed herein. In an embodiment, the communication device 100 may include for example, but not limited to, smart phone, tablet, PDA, and any other digital computing device. The FIG. 1 shows three different operating systems on the system 100: a personal operating system 302 and, a protected operating system 304 (as the one or more secondary operating systems) and a secure operating system 306 (as the primary operating system). The loading module 212 is configured to lead the primary operating system (secured operating system 306) onto the system 100. The loading module 212 further loads the one or more secondary operating systems onto the system 100 based on authentication. The primary operating system 306 performs an authentication check of the one or more secondary operating systems i.e. the personal operating system 302 and the protected operating system 304 in the system 100. The one or more secondary operating systems are authenticated in accordance with an authentication value and rule assignation mechanism. After the authentication, the communication module 216 enables a secure communication between the one or more secondary operating systems.

In an embodiment, the personal operating system 302 may comprise personal data, applications, games, personal calendar, photos, videos, music and the like. In an embodiment, the personal operating system 302, and the protected operating system 304 may be created by a hypervisor with the personal operating system 302 acting like a host device and the protected operating system 304 a guest device. The hypervisor separates the protected operating system from the personal operating system using a memory management unit (MMU), placing the secondary operating system inside a virtual machine.

In an embodiment, the secure operating system 306 may be memory curtained. The memory curtaining may be done by using technologies like Trustzone, Intel TXT and the like. The secure operating system 306 runs at a higher privilege level than the personal operating system 302, and the protected operating system 304. The secure operating system 306 is configured to be a read-only operating system, and transfers data between the one or more operating systems (the personal operating system, and protected operating system).

The read-only type characteristic of the secure operating system 306 may not allow any applications or data to be downloaded. The read only type characteristic may ensures that the secure operating system 306 may not be manipulated, infected with malware, and is secure from attacks.

In an embodiment, the protected operating system 304 may comprise enterprise data, banking applications, enterprise environment, and the like. Although FIG. 3, shows that the communication device 100 contains the personal operating system 302 and the protected operating system 304 besides the secure operating system 306, it is to be understood the communication device 100 may be configured to have multiple operating systems created by virtualization software (example hypervisor), or memory curtaining.

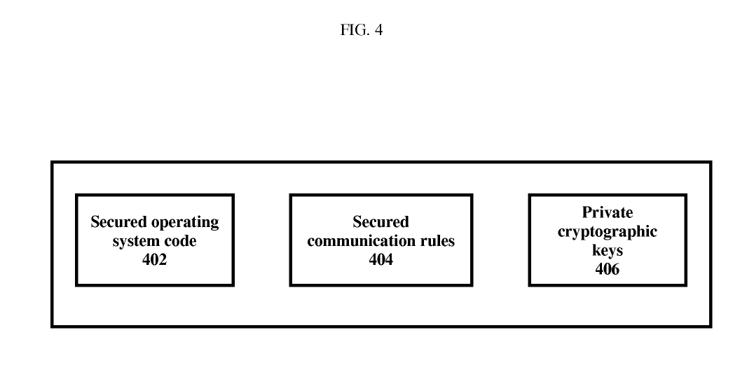

Referring to FIG. 4 is a diagram that illustrates details of components loaded in the memory 208 of the secured operating system 306, according to embodiments as disclosed herein. When the secure operating system 306 is loaded three components are loaded from a secured operating system code 402, secured communication rules 404, and private cryptographic keys 406. The secure operating system code comprises of code required for conducting memory inventory and the like.

The secured communication rule 404 (simply rules) comprises rules related to communication between the personal operating system 302 and protected operating system 304. The secure communication rules are downloaded by the secure operating system 306 and may not be altered. wait

The rules define what data may be shared between the personal operating system 302, and the protected operating system 304. In an embodiment, the rules may be configured to specify scanning mechanisms that may be used when data is shared between the personal operating system 302, and protected operating system 304.

The private cryptographic keys 406 contain information required for authenticating the personal operating system 302, and the protected operating system 304. In an embodiment, a hash value is generated for the secured operating system code 402, secured communication rules 404, and private cryptographic keys using hash algorithm like CRC32, MD5, SHA-1 and the like. A checksum of hash computed for the secure operating system code 402, secured communication rules 404 and private cryptographic keys 406 is performed while booting of the communication device 100 to ensure integrity of the secure operating system 306. The hash checksum mechanism compares the computed checksum with a stored checksum value. If the values match, the data (secured OS code 402, secured communication rules 404 and private cryptographic key 404) may be considered free of any alternations, errors, corruption, and the like. Mention details as example

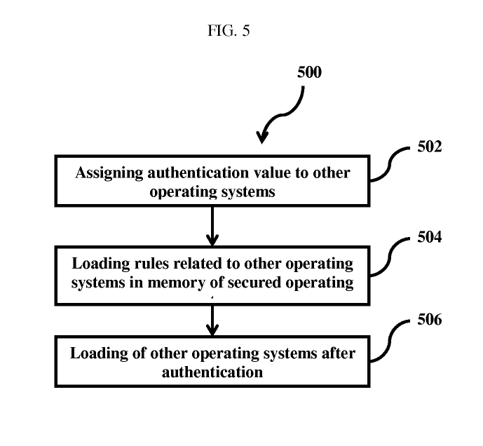

FIG. 5 is a flow chart that illustrates a method 500 for authenticating operating systems, according to embodiments as disclosed herein. Once the secure operating system 306 is loaded by the loading module 212, the secure operating system 306 checks and authenticates the one or more secondary operating systems. In an embodiment, at step 502, the secure operating system 306 is configured to assign an authentication value to the one or more secondary operating systems based on the security level. In an embodiment, the secured operating system 306 assigns rules for the one or more secondary operating systems based on the authentication value.

In an example of authentication, where a private-public key is associated with each of the primary and the one or more secondary operating system. The private-public key pair may be checked using asymmetric cryptography. The one or more secondary operating systems may be authenticated only if they have the private key associated with the public key. In an embodiment, at step 504 the rules related to the one or more secondary operating systems are loaded into the memory of the secured operating system 306. The rules loaded into the memory may be different for each of the one or more secondary operating system. Rules may be different as per classification of operating system (Personal (usually source of information), Protected (usually destination of information), Transient (wherein the information may not be part of any communication) and so on. Depending on authentication result, the one or more secondary operating systems may be classified. In an embodiment, at step 506, once the authentication is cleared, the one or more secondary operating systems are loaded, and start operating.

In an embodiment, the secure operating system 306 allows the personal operating system 302 and protected operating system 304 to communicate based on the rules assigned to each. The various operations described with respect to the FIG. 5 may be performed in the order presented, or simultaneously, or parallel, or in any different order. The operations described herein are only for illustrative purpose and do not limit the scope of the embodiment. Further, in some embodiments, some of the operations can be added, skipped, omitted, or modified without departing from the scope of the embodiment.

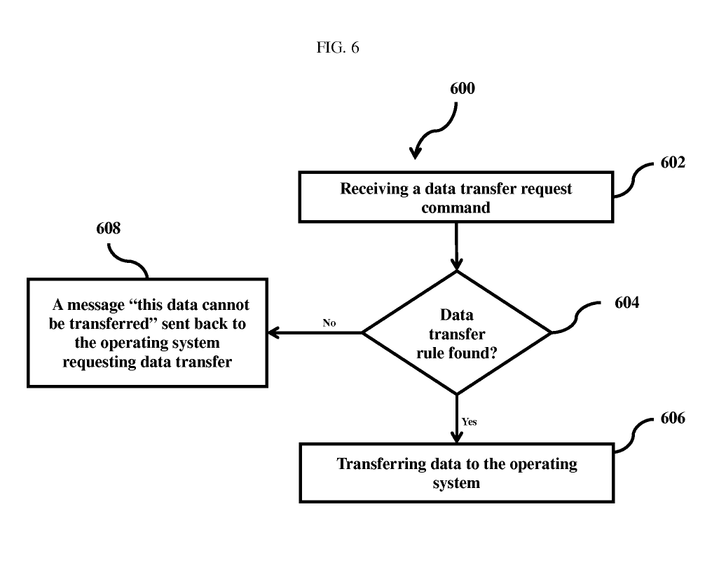

FIG. 6 is a flow chart that illustrates a method for secure communication between the personal operating system 302 and the protected operating system 304 using the secure operating system 306, according to embodiments as disclosed herein. In an embodiment, at step 602 a data transfer request command is received by the secured operating system 306. Consider an example, where the personal operating system 202 wants to share an event in the calendar with the protected operating system. The personal operating system 302 sends a data transfer request command to the secure operating system 306. In an embodiment, at step 604, a command handler at the secure operating system 304 checks if, the data transfer request command is valid, and a data transfer rule is found in a rules memory. The secured operating system 306 is configured to check the rules assigned to the one or more secondary operating systems and determined if a data transfer rule exists. At step 406, if a valid rule related to the data transfer request is present, the data transfer is allowed. The command handler in the secured operating system 306 is configured to read the data in the data transfer request and send the data to the other operating system.

In an example embodiment, when a vcard from a personal operating system 302 needs to be transferred to the protected operating system 306. The secured operating system 306 may have a rule allowing vcard to be transferred from the personal operating system 302 to the protected operating system 306. In an embodiment, the secured operating system 306 can include rules to include malware scanning to ensure secure data transfer. In an embodiment, the secure operating system 306 is configured to encrypt the data which is being transferred between the one or more secondary operating systems. The various operations described with respect to the FIG. 6 can be performed in the order presented, or simultaneously, or parallel, or in any different order. The operations described herein are only for illustrative purpose and do not limit the scope of the embodiment. Further, in some embodiments, some of the operations can be added, skipped, omitted, or modified without departing from the scope of the embodiment.

In an embodiment, a system 100 and method is provided for protecting password screen from phishing attack. The password screen is protected by saving anti-phishing data in a secure operating system 306 running on the mobile device 104-N.

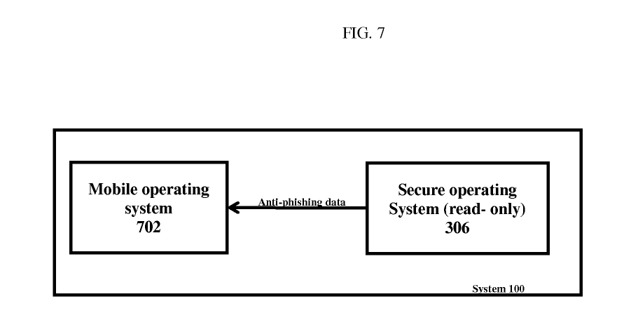

FIG. 7 is a diagram that illustrates a high level architecture of a system 100 in which a read-only secure operating system 306 is embodied, according to embodiments as disclosed herein. The read-only secured operating system 306 may be only limited to code and execution path of operating system meaning no programs or executables can be added/altered/deleted to the operating system.

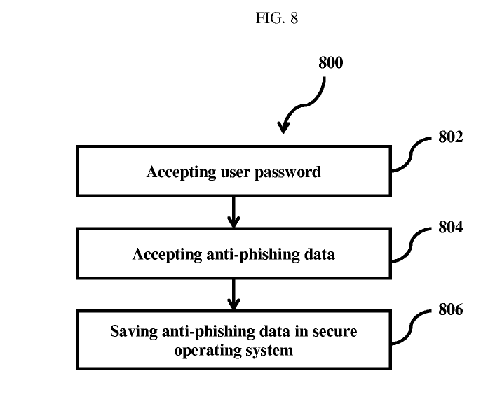

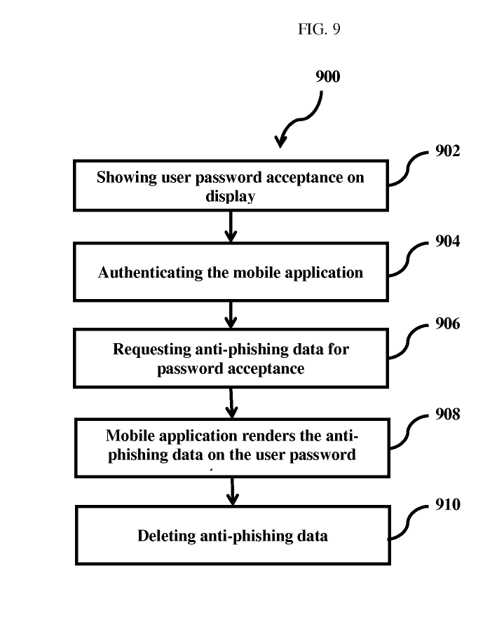

A mobile operating system 702 *mention primary secondary is the operating system of the mobile device 104. Check with diagram In an embodiment, the secure read-only operating system 306 is configured to store anti-phishing data. The read-only secure operating system 306 ensures that the secure operating system 306 may not be manipulated, infected with malware, and is secure from attacks. This ensures that no application or code may be installed or modified inside the secure operating system 306. The password screen may be augmented with anti-phishing data. In an embodiment the anti-phishing data, may include for example, but not limited to text, image, identity cue, security skin, dynamic grid of images and the like. In an embodiment, password along with the anti-phishing data associated with the password screen can be stored in the read-only secured operating system 306. The saving of password and anti-phishing data in the secure operating system 306 may allow usage of mobile applications in domains where security is critical. In an embodiment, the domains described herein may include, but not limited to, defense, enterprise, banking, medicine and the like. The anti-phishing data related to multiple applications may be stored in the secure operating system 306. FIG. 8 is a flow chart that illustrates a method 800 for setup of anti-phishing data during password setup process, according to embodiments as disclosed herein. In an embodiment, at step 802, when a mobile application password step up process is initiated, the password created by the user is accepted by the application. In an embodiment, at step 804, the system 100 is configured to accept anti-phishing data related to the password. Consider an example, of a mobile banking application, where the user defines a password, and selects an image, and text to appear on the screen along with the password. In an embodiment, at step 806, the anti-phishing data along is saved in the secure operating system 306. In an embodiment, anti-phishing data related to various applications or web service providers may be stored in the secure operating system 306. The secure operating system 306 is configured to store information related to the mobile application/web service whose anti-phishing data is stored. The various operations described with respect to the FIG. 8 may be performed in the order presented, or simultaneously, or parallel, or in any different order. The operations described herein are only for illustrative purpose and do not limit the scope of the embodiment. Further, in some embodiments, some of the operations can be added, skipped, omitted, or modified without departing from the scope of the embodiment. FIG. 9 is a flow chart that illustrates a method 900 for retrieving anti-phishing data from the secure operating system 306 during a password acceptance process, according to embodiments as disclosed herein. In an embodiment, at step 902, a user password acceptance screen is shown by a mobile application requesting password. In an embodiment, at step 904, the mobile application requesting password is authenticated by the secured operating system 306. The authentication of the mobile application ensures that a genuine application is requesting for anti-phishing data. In an example authentication method, the application is pre-signed with a particular signature, wherein only signed applications will be able to request the anti-phishing data. Consider an example, where a social networking application, shows the user password acceptance screen. Once the screen user password acceptance screen is displayed and the user enters password, the social networking application is verified by the secured operating system. Consider an example, when a user is trying to access a service provider application and is requested for a password. The secured operating system 306 will check if the service provider requesting the password is genuine.

At step 906, the secure operating system 306 is configured to receive request for transfer of anti-phishing data related to password acceptance of the mobile application. In an embodiment, the secured operating system 306 is configured to provide the anti-phishing data related to the password acceptance of the mobile application. At step 908, the secure operating system 906 displays the anti-phishing data on the user password acceptance screen. After a successful acceptance of password, the anti-phishing data displayed is deleted from the application running in the mobile operating system. The various operations described with respect to the FIG. 9 may be performed in the order presented, or simultaneously, or parallel, or in any different order. The operations described herein are only for illustrative purpose and do not limit the scope of the embodiment. Further, in some embodiments, some of the operations can be added, skipped, omitted, or modified without departing from the scope of the embodiment.

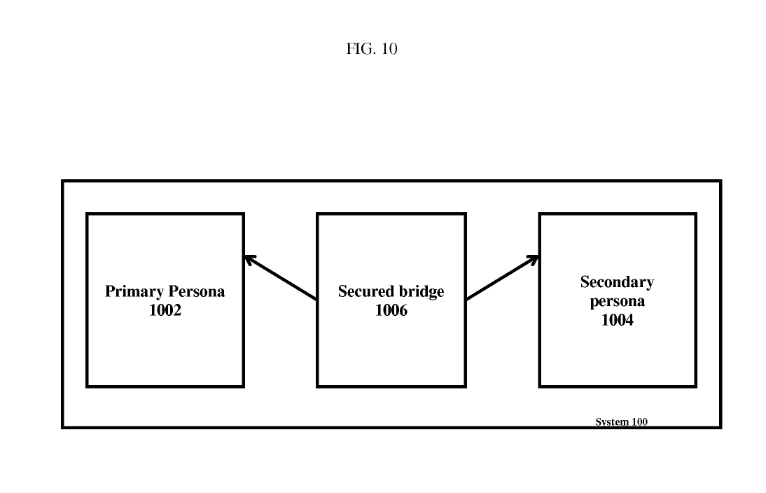

FIG. 10 is a diagram that illustrates a high level architecture of a secure communication bridge between two different personas, according to embodiments as disclosed herein. FIG. 10 shows the system 100 with two different personas of the user. The primary persona 1002 runs on a mobile operating system of the system 100. The system here may be considered as a mobile device for a purpose of explanation.

In an embodiment, the primary persona 1002 may be a personal persona and comprises of its own applications, operating system, and the like. A hypervisor application is used to create a secondary persona 1004. In an embodiment, the secondary persona 1004 may be provided by an enterprise. The secondary persona 1004 may work on a different operating system; have its own operating system, applications and the like. The secondary persona 1004 of the user may include for example, but not limited to, an enterprise persona, a banking persona and the like. A secure bridge 1006 is created to communicate between the primary persona 1002 and the secondary persona 1004. The secure bridge 1006 is configured to have rules and security check to enable secure communication of data between the primary persona 1002 and the secondary persona 1004. In an embodiment, the user may switch between the primary persona 1002, and the secondary persona 1004 via an icon on a desktop of active persona. In an embodiment, one persona of the user is active, and other remains in the background. In an embodiment, the user may select the background persona to activate it. The secondary persona 1004 may not exist if the primary persona 1002 is not available.

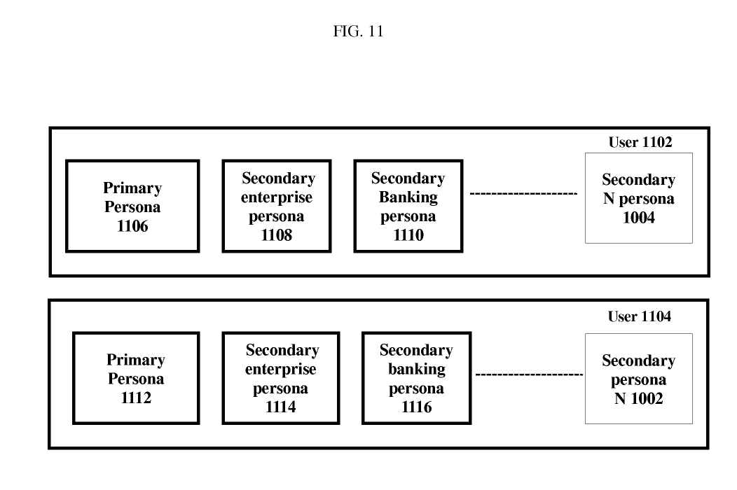

FIG. 11 is an exemplary diagram illustrating multiple users having multiple personas on the system 100 (here mobile device) according to embodiments as disclosed herein. A user 1102, 1104 may have a personal primary persona 1106, 1112 and plurality of secondary personas (1108, 1110, 1114, 1116) ranging from 1-N. The FIG. 11 shows user 1102 having a secondary enterprise persona 1108, and a secondary banking persona 1110. The various persona of the user 1102, 1104 may be created using a hypervisor application. Another user 1104 has personal primary persona 1112, a secondary enterprise persona 1114, and a secondary banking persona 1116. When a user 1102, 1104 is created, the primary persona is generally the personal persona.

In an embodiment, the personal persona is configured to include user's personal contacts, music, video, photos, organizer and the like. The secondary persona can be created only if the primary persona exists. The secondary enterprise persona 1108, 1114 may be created using an on device option in the setting of the primary persona of the mobile device. In another embodiment, the secondary enterprise persona 1108, 1114 may be created by the enterprise the user works for. The active persona has screen focus and the other personas are the background. The user can switch between the active persona and the secondary persona. If persina is appMemory space segregation for different personas may be performed using multi-user frameworks of mobile operating systems. Switching is done at the mobile operating system level co-operatively between the personas, where processes of one persona are pushed in background (meaning no longer take screen control).

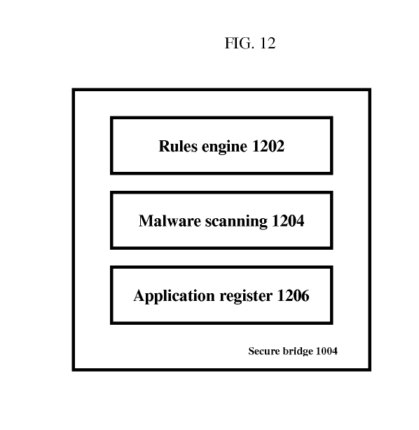

FIG. 12 is a diagram that illustrates the secure bridge 1006, according to embodiments as disclosed herein. The secure bridge 1006 includes a rules engine 1202, a malware scanner 1204, and an application register 1206. The application register 1206 contains all the applications from the primary persona 1002 and secondary persona 1004 who wish to share, and sync data between themselves. All the applications which wish to share data register themselves with the application register 1206 of the secure bridge 1006. Consider an example, when a calendar application in a primary persona 1002 wishes to sync data with the calendar application of the secondary persona 1004. The calendar application of both the primary persona and the secondary persona need to register with the application register 1206. The secure bridge 1006 is configured to receive a modification log from the active persona, when the user switches to another persona. The modification log comprises of all the changes (add, delete, remove, modify and the like) made by the user in application which is registered with the secure bridge 1006 in the application register 1206. Consider an example, when a user is on the primary persona 1002 (active persona) and the user has added a contact in the contact application. When the user switches from the primary persona 1002 to another persona, the modification log contains data related to the new contact.

In an embodiment, the secure bridge 1006 is configured to check if the data in modification log is free of malware. A malware scanner scans all the data present in the modification log. This ensures that no malware can be introduced into the other persona or the other operating system. In an embodiment, the secure bridge 1006 is configured to check if a rule exists to allow the data sync requested. The secure bridge 1006 is configured to copy data (related to an application) present in the modification log into the respective application in the secondary persona 1004 selected by the user.

The rules engine 1202 contains rules regarding syncing, and transfer of data. The secure bridge 1006 also contains rules related to data types. For example, only certain pre-defined data types will be allowed to sync between the applications of the multiple personas.

Consider an example of a rule for sharing contacts between the primary persona, and the secondary persona:

RULE 1—Share contact information from primary persona 1002 to secondary persona 1004 as read only
RULE 2—No sharing of contact information from secondary persona 1004 to primary persona 1002
As per rule 1, if the user makes changes in the contact application (adds new contact, edits an existing contact, and deletes contact and the like) in the primary persona 1004, a modification log contacting the changes made in the contact application is sent to the secure bridge. The secure bridge 1006 then checks, if a valid rule related to contact sharing from primary persona 1002 to secondary persona 1004 is present and may to allow, the data present in modification log to be copied into the secondary persona. If a valid rule is present, the secure bridge 1006 will copy the changes in contact application as read-only in the secondary persona 1004.
As per Rule 1, if user makes changes to a contact in the secondary persona 1004 (active persona), a modification log may be sent by the secondary persona 1004 to the secure bridge 1006, when the user switches to primary persona 1002. The secure bridge 1006 may not copy the changes from the modification log into the primary persona 1002, as the rule may not allow sharing of contact information from the secondary persona 1004 to the primary persona 1002.

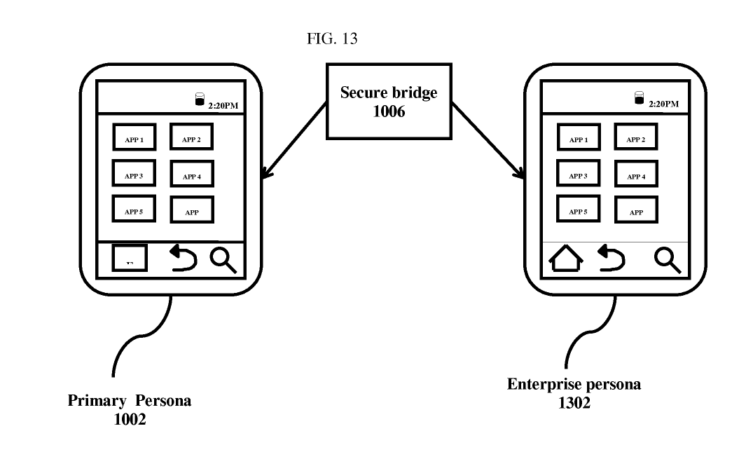

FIGS. 13 A and 13B shows and example of a primary persona 1002 and an enterprise persona 1302 on the system 100 (here mobile device), according to embodiments as disclosed herein. The enterprise persona 1302 is a secondary persona on the system 100. Only one of the personas (primary persona 1002/enterprise persona 1302) may be active at any given time. Each persona (primary and enterprise) contains of applications (aap1, app2 - - - app n) as shown in the FIG. 13. Many of the applications may be similar on both of the persona (primary persona/secondary persona). For example, both the personas (1002, 1004) may have a calendar application, contact database and application, photo application, media player application and the like. In an embodiment, the secure bridge 1006 between the primary persona 1302 and the enterprise persona 1302 is configured to sync data securely between the personas. An icon called E is created on the primary persona 1002. When the user selects this icon, he may switch to the enterprise persona 1302. When the enterprise persona 1302 is active, the user may select a home button on the enterprise persona 1302 screen to select the primary persona 1002.

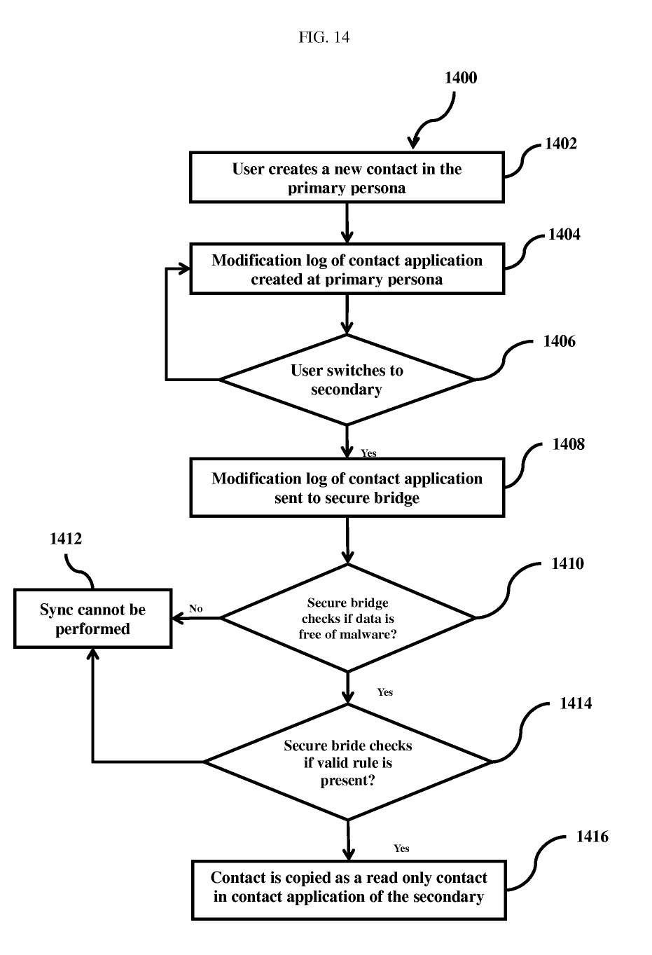

FIG. 14 is an exemplary flow chart that illustrates a method for contact sync from a primary persona to a secondary persona using a secure bridge, according to embodiments as disclosed herein. Contacts may not be added from the secondary persona 1004 to the primary persona 1002. The contacts in the secondary persona 1004 are considered secure and may hold confidential data which may not be shared with the primary persona 1002. In an embodiment, at step 1402, the user creates a new contact in the primary persona 1002. In an embodiment at step 1404, the primary persona 1002 creates a modification log containing the contact added by the user. At step 1406, the user switches from the primary persona 1002 to the secondary persona 1004. The user may switch to the secondary persona 1004 by selecting the background persona. At step 1408, if the user switches to the secondary persona 1004, the modification log of the contact application is sent to the secure bridge 1006. At step 1410, the secure bridge 1006 checks if the contact data in the modification log is free of malware. At step 1412, if the contact data in the modification log contains malware, sync may not be performed. At step 1414, if the contact data in modification log is free of malware, the secure bridge checks if there is a valid rule. At 1216, the created contact is copied into the content application of the secondary persona 1004 as a read-only contact, if a valid rule is present. The contact is copied into the secondary persona 1004 as read only contact, and may not be altered by the secondary persona 1004. Although the example described in FIG. 14 relates to adding of contact, it is to be understood that the same process may be used to sync data from the primary persona 1002 to the secondary persona 1004, when a contact is edited, deleted, or modified in any way. The various operations described with respect to the FIG. 14 may be performed in the order presented, or simultaneously, or parallel, or in any different order. The operations described herein are only for illustrative purpose and do not limit the scope of the embodiment. Further, in some embodiments, some of the operations can be added, skipped, omitted, or modified without departing from the scope of the embodiment.

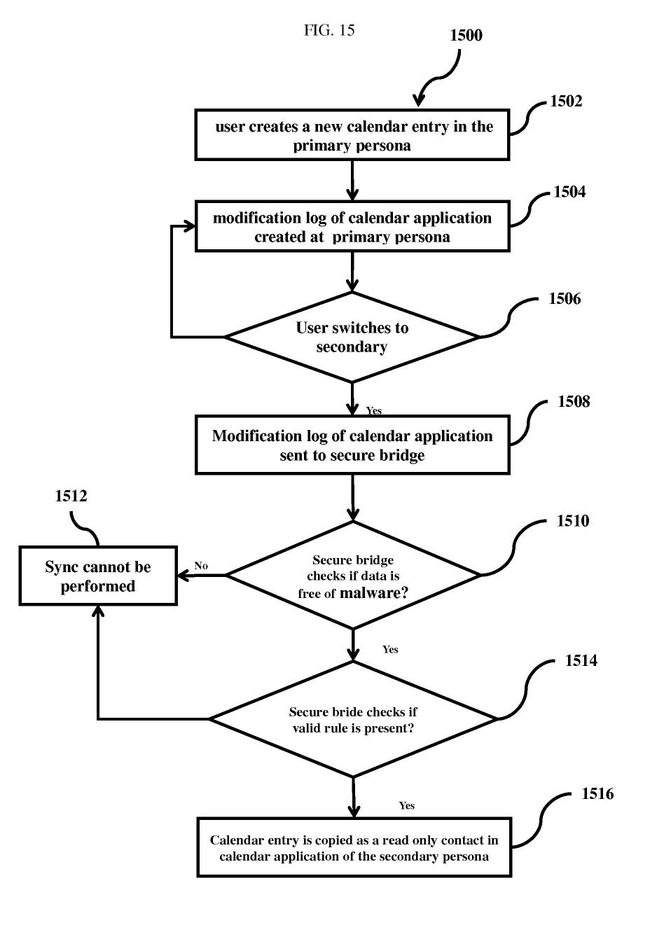

FIG. 15 is an exemplary flow chart that illustrates a method for calendar sync from the primary persona 1002 to the secondary persona 1004 using a secure bridge 1006. At step 1502, the user creates a new calendar event in the primary persona 1002. At step 1504, the primary persona 1002 creates a modification log containing the calendar event added by the user. At step 1506, the user switches from the primary persona 1002 to a secondary persona 1004. The user may switch to the secondary persona 1004 by selecting the background persona. If the user switches to a secondary persona 1004, the modification log of the calendar application is sent to the secure bridge 1006. At step 1508, the secure bridge 1006 receives the modification log from the primary persona 1002. At step 1510, the secure bridge 1006 checks if the calendar data in the modification log is free of malware. At step 1512, if the calendar data in the modification log contains malware, sync may not be performed. At step 1514, if the calendar data in modification log is free of malware, the secure bridge 1006 checks if there is a valid rule present. At 1516, if a valid rule is present the calendar entry is copied into the content application of the secondary persona 1004. The calendar entry may be as a read-only calendar entry, and may not be altered in the secondary persona 1004. Although the example described in FIG. 13 relates to adding of a calendar event, it is to be understood that the same process can be used to sync calendar data from the primary persona to the secondary persona 1004, when a calendar event is edited, deleted, or modified in any way. Consider an example, when a user creates a calendar event on 11^{th} of September for an “Eva's birthday party”, in the primary persona 1002. On the secondary persona 1004, the calendar event may be synced, and shown as “Eva's birthday party” for the 11^{th} of September. All the fields in the calendar event are copied from the primary persona 1002 to the secondary persona 1004. The various operations described with respect to the FIG. 15 may be performed in the order presented, or simultaneously, or parallel, or in any different order. The operations described herein are only for illustrative purpose and do not limit the scope of the embodiment. Further, in some embodiments, some of the operations can be added, skipped, omitted, or modified without departing from the scope of the embodiment.

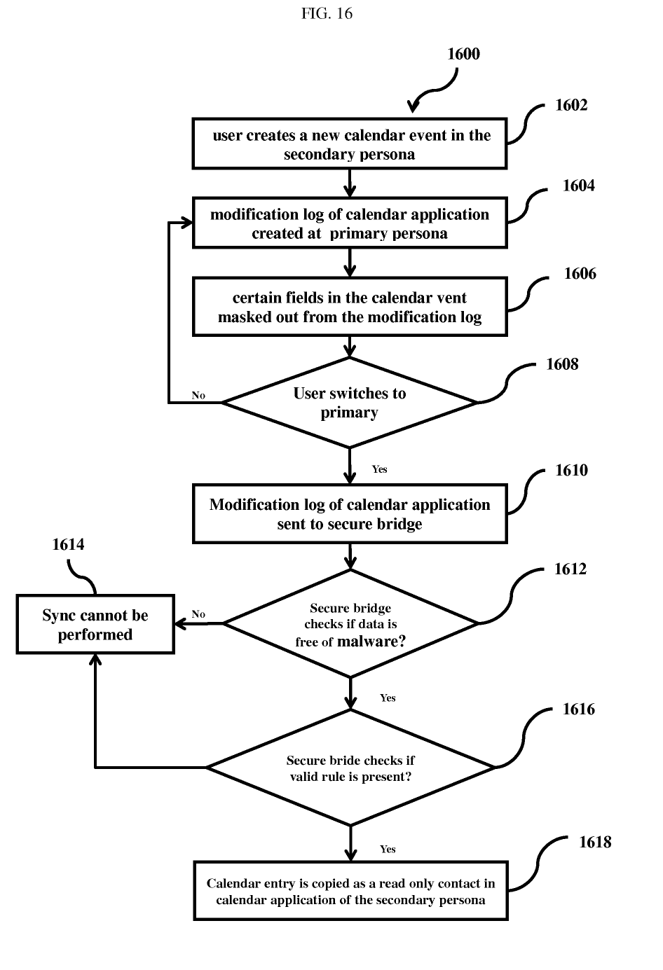

FIG. 16 is an exemplary flow chart that illustrates a method for calendar sync from the secondary persona 1004 to the primary persona 1002 using the secure bridge 1006. At step 1602, the user creates a new calendar event in the secondary persona 1004. At step 1604, the secondary persona 1004 creates a modification log containing the calendar event added by the user. at step 1606, certain fields in the calendar event are masked out from the modification log. This masking is performed by the secondary persona 1004. At step 1608, the user switches from the secondary persona 1004 to the primary persona 1002. The user may switch to the primary persona 1002 by selecting the background persona. At step 1610, the modification log of the calendar application is sent to the secure bridge 1006, when the user switches to the primary persona 1002. At step 1612, the secure bridge 1006 checks if the calendar data in the modification log is free of malware. At step 1614, if the calendar data in the modification log contains malware, sync may not be performed. At step 1616, if the calendar data in modification log is free of malware, the secure bridge 1006 checks if a valid rule is present. At step 1618, the calendar event is copied into the content application of the primary persona 1002, if a valid rule is present. The calendar event may be as a read only calendar entry, and may not be altered in the secondary persona. Although the example described in FIG. 16 relates to adding of a calendar event, it is to be understood that the same process may be used to sync calendar data from the secondary persona to the primary persona, when a calendar event is edited, deleted, or modified in any way. Consider an example, when a user creates a calendar event on 5^{th} of November for a “meeting with client xyz”, at client premises in the secondary persona 1004. On the primary persona 1004, the calendar event will be synced, and shown as “meeting” for the 5^{th} of November. All the fields in the calendar event are not copied from the secondary persona 1004 to the primary persona 1002.

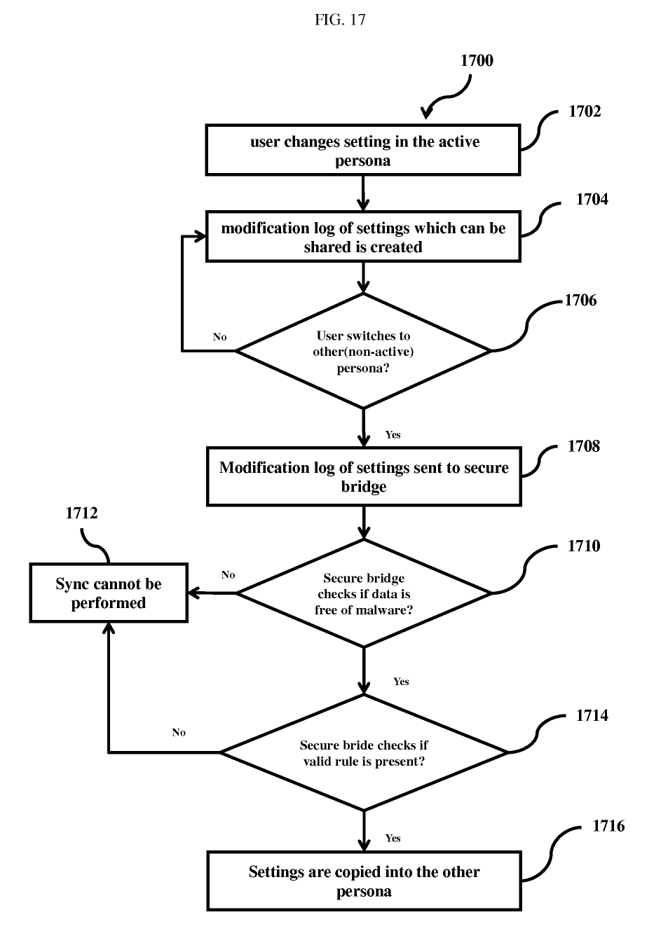

FIG. 17 is an exemplary flow chart that illustrates a method 1700 for settings sync between the secondary persona 1004 and a primary persona 1002. At step 1702, the user modifies settings in the active persona. At step 1704, the active persona creates a modification log containing the settings modified by the user. At step 1706, the user switches from the active persona to other persona. The user may switch to the other persona by selecting the background persona. At step 1708, the modification log of the settings is sent to the secure bridge, when the user switches to the other persona. At step 1710, the secure bridge 1006 checks if the data in the modified settings in the modification log are free of malware. At step 1712, if the modified settings in the modification log contain malware, sync may not be performed. At step 1714, if the calendar data in modification log is free of malware, the secure bridge 1006 checks if a valid rule is present. At step 1716, modified settings are copied into the other persona (selected by the user), if a valid rule is present. The rules in secure bridge 1006 may not allow some settings to be copies. Every person may have settings which may be shared. Only these setting may be shared with other persona. For example, the background setting in the primary persona 1002 may not be shareable with the secondary persona 1004. The various operations described with respect to the FIG. 17 may be performed in the order presented, or simultaneously, or parallel, or in any different order.

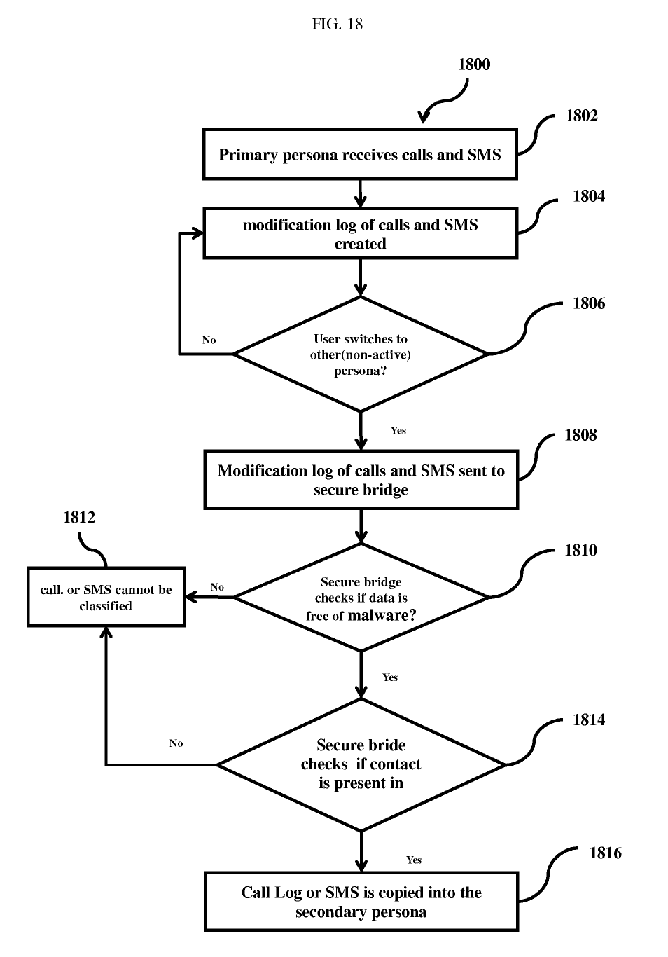

FIG. 18 is a flow chart that illustrates a method 1800 for classifying calls and incoming messages to a persona, according to embodiments as disclosed herein. At step 1802, the primary persona 1002 is configured to receive all calls and SMS. When a user receives a call or an SMS it is shown in active persona. At step 1804, the primary persona creates a modification log containing the calls and SMS received by the user. At step 1806, the user switches to other personas. The user may switch to the background persona. At step 1808, the modification log of the SMS and calls is sent to the secure bridge 1006, when the user switches to the background persona. At step 1810, the secure bridge checks if the SMS and calls in the modification log are free of malware. At step 1812, if the SMS and calls in the modification log contain malware, sync may not be performed. At step 1814, if the SMS in modification log is free of malware, the secure bridge checks if a SMS and calls are related to contacts present in the secondary personas contact application. At step 1816, the SMS and call logs are copied into the secondary persona. The various operations described with respect to the FIG. 18 can be performed in the order presented, or simultaneously, or parallel, or in any different order.

In an embodiment, the system 100 and method is provided for selectively disabling access to protected data on the mobile, in case the integrity of the mobile operating system is compromised. The integrity of the mobile operating system may be assured if it can be defended against modification by attackers. The protected data on the mobile device may include for example, but not limited to, username, password, banking information enterprise related data and the like. In an embodiment, access is granted to protected data after a password input from user, and a matching integrity value. Multiple user personas can exist on the mobile device, as described in FIG. 10.

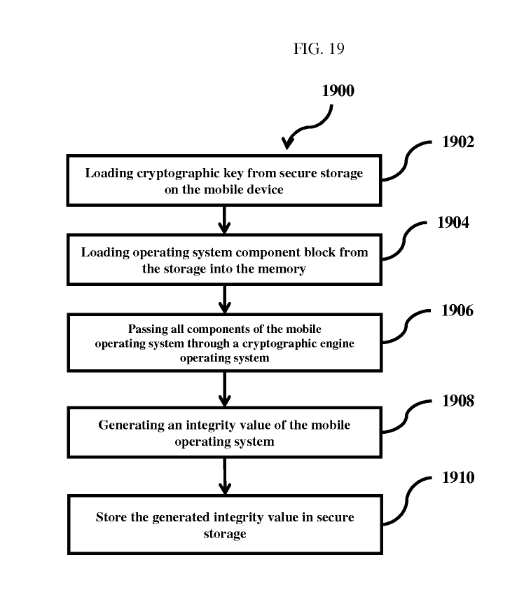

FIG. 19 is a flow chart that illustrates a method 1900 for generating an integrity value for an operating system in the system 100 (mobile device) during the booting process, according to embodiments as disclosed herein. A secure storage is created in the mobile operating system. The secure storage may be a read only storage, for storing the integrity value of the mobile operating system, and for storing cryptographic public key. In an embodiment, the secure storage may be created by memory curtaining of the mobile operating system. At step 1902, the cryptographic public key is loaded from the secure storage. The cryptographic public key helps in authentication of all the components of the operating system. At step 1904, the component blocks of the operating system are loaded from the secure storage into the memory. The components may include the secure operating system code, communication rules, malware scanner and the like. At step 1906, all the components of the operating system are passed through a cryptographic hash engine. The cryptographic hash engine uses the public key to authenticate and create a value for each components of the operating system. At step 1908, an integrity value for the mobile operating system is generated by doing a hash checksum, of all the calculated values of components of the operating system. At step 1910, this integrity value is stored in the secure storage of the mobile operating system. The various operations described with respect to the FIG. 19 can be performed in the order presented, or simultaneously, or parallel, or in any different order.

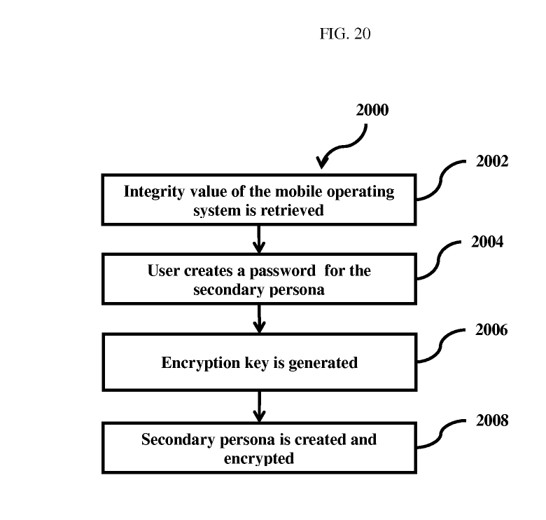

FIG. 20 is a flow chart that illustrates a method for creating an encrypted partition key for the secondary persona 1004, according to embodiments as disclosed herein. The secondary persona 1004 described herein may include an enterprise persona, a banking persona, or any other persona with sensitive data. At step 2002, while creating the secondary persona 1004, the integrity value of operating system is loaded from the secure storage. At step 2004, a user creates a password for accessing the secondary persona 1004. At step 2006, the system 100 is configured to generate an encryption key for the secondary persona 1004. The encryption key is a combination of the integrity value of the operating system and, the user entered password for the secondary persona 1004. At step 2008, the secondary persona 1004 is created and encrypted with the encryption key. The various operations described with respect to the FIG. 20 can be performed in the order presented, or simultaneously, or parallel, or in any different order.

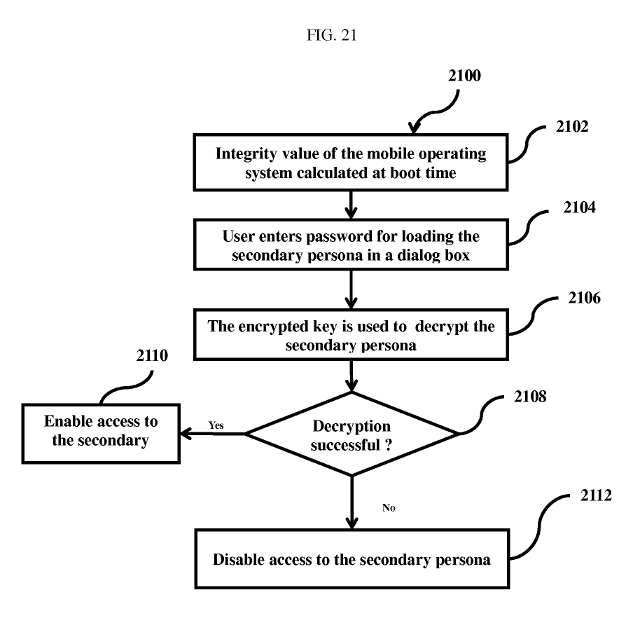

FIG. 21 is a flow chart that illustrates a method for loading the secondary persona 1004, according to embodiments as disclosed herein. In an embodiment, at step 2102, the integrity value of the operating system is retrieved from the secure storage. Each time the operating system of the mobile device is loaded, the integrity value of the operating system is recalculated. The calculated integrity value of the operating system is compared with pre stored integrity value. In an embodiment, when the integrity value is comprised, the operating system continues to load and the user may receive a message indicating there has been an attack on the mobile device. At step 2104, the user is shown a dialog box to enter password for loading the secondary persona. At step 2106, the encrypted key is used to decrypt the secondary persona 1004 and load the secondary persona 1004. At step 2108, the system 100 is configured to check if the decryption process is successful. At step 2110, if the decryption is successful, the secondary persona 1004 is loaded and user can access the secondary persona. At step 2110, in case decryption is unsuccessful, access to the secondary persona is disabled, and the secondary persona does not load. The unsuccessful decryption may be due to incorrect password or change in integrity value. If the integrity value used for decryption is not the same as the one present in the encryption key, access to secondary persona is disabled. The various operations described with respect to the FIG. 21 may be performed in the order presented, or simultaneously, or parallel, or in any different order.

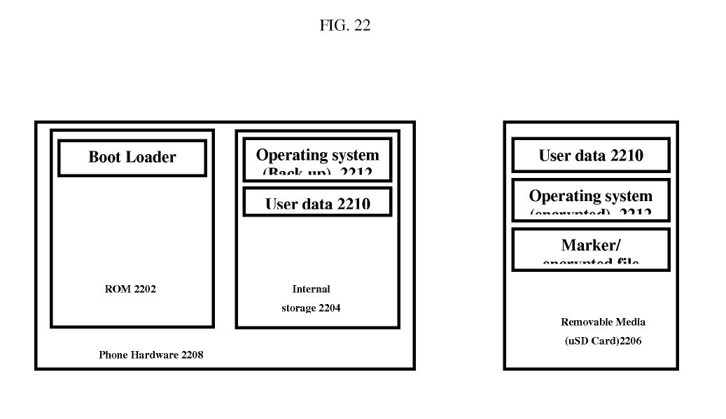

FIG. 22 is a diagram that illustrates a high level architecture of components required for loading of a mobile operating system in the system 100, according to embodiments as disclosed herein. The loading of a mobile operating system requires phone hardware 2208, comprising of a read only memory (ROM) 2202 and an internal storage 2204, and a removable media 2206. The ROM 2202 contains the boot loader 2216. The bootloader 2216 is modified to read the removable media 2206. The bootloader 2216 may have special driver to communicate with the removable media 2006. The bootloader 2216 is loaded into the memory by the hardware to start the boot loading process. The removable media 2206 is a hardware encrypted MicroSD card, which may include a marker/encrypted file 2014, user data 2210 and an operating system 2212 for the system (mobile device). The removable media 2206 will have an operating system firmware image, including the kernel, and the system binaries. In an embodiment, a Java card applet running on the removable media is configured to decrypt the firmware images. The boot loader 2216 is configured to load the operating system from the removable media 2206, after the firmware present in removable media is authenticated. The removable media 2206 may include for example, but not limited to, Go-Trust secure MicroSD, KoolSpan TrustChip and the like. In an embodiment, the internal storage comprises of the user data 2210 and a back up operating system 2212.

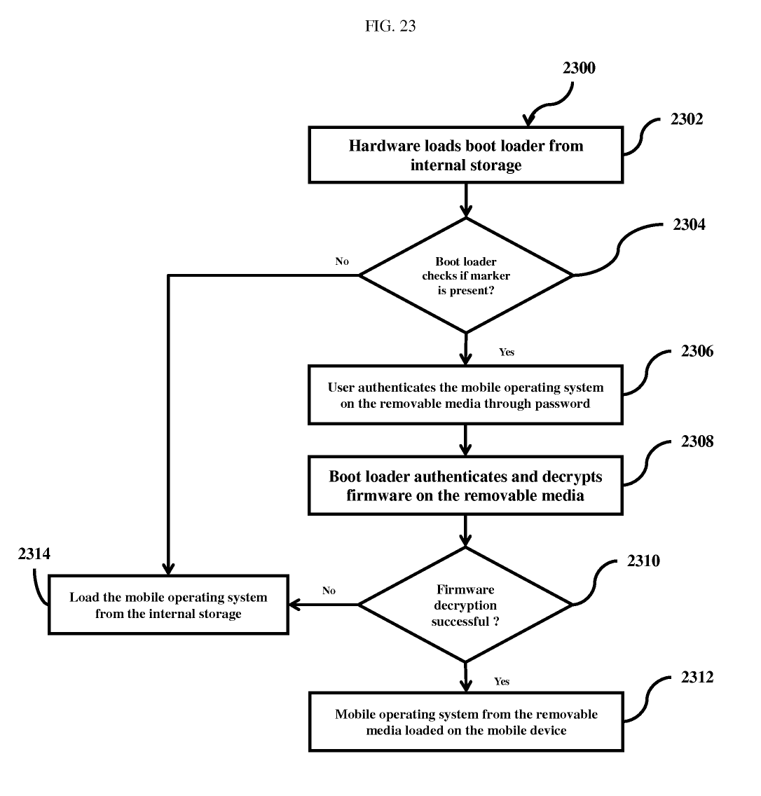

FIG. 23 is a flow chart that illustrates a method for secure loading of the mobile operating system from a removable media, according to embodiments as disclosed herein. At step 2302, the hardware loads the bootloader from the internal storage. In an embodiment, at step 2304, the bootloader is configured to check if the marker is present in the removable media. At step 2314, the operating system is loaded into the mobile device from the internal storage. At step 2306, the user authenticates the operating system 2312 present on the removable media 1206 using a password. In an embodiment, at step 2308, the bootloader is configured to authenticate the firmware images stored in the removable media 2206. The firmware images are stored in the removable media 2206 are encrypted. The bootloader is configured to authenticate, and decrypt the firmware. In an embodiment, the boot loader is configured to authenticate the user before decrypting the firmware. The boot loader generates a NONCE (unique pseudo-random number). A near filed communication (NFC) device encrypts the NONCE with a public key. An authority token generated by the NFC has the same root certificate authority (CA) as the one present in the removable media. The encrypted NONCE with corresponding public key is sent to the removable media. In an embodiment, the removable media 2206 is configured to verify if the public key is trustable and decrypt the firmware. At step 2310, the system is configured to check if the firmware decryption is successful. In an embodiment, at step 2312 the operating system is loaded from the removable media in case of successful decryption of firmware. Mention as example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for providing a secure communication between multiple operating systems in a communication device, the method comprising:
loading a primary operating system in the communication device;
performing through the primary operating system, an authentication check of one or more secondary operating systems in the communication device, wherein the one or more secondary operating systems are authenticated based on rule assignation; and
enabling a secure communication between the one or more secondary operating systems after the authentication.

2. The method as claimed in claim 1, wherein the authentication check is based on a public-private key using asymmetric cryptography.

3. The method as claimed in claim 1, wherein the rules are assigned to classify the one or more secondary operating systems.

4. The method as claimed in claim 1, wherein the enabling the secure communication comprises:
receiving a data transfer request command by the secure operating system from the one or more operating systems;
checking an existence of rule corresponding to the data request command with at least one request authentication rule;
allowing the transfer of the data based on the checking.

5. The method as claimed in claim 1, wherein the primary operating system is configured to protect password screen from anti-phishing attack by saving anti-phishing data in the primary operating system, wherein the password is further protected by authenticating mobile application requesting for password while sharing anti-phishing data.

6. The method as claimed in claim 1, further comprising:
creating multiple personas for the communication device, wherein the multiple personas comprises a primary persona and a secondary persona; and
enabling a secure communication between multiple personas through a secure bridge.

7. The method as claimed in claim 6, wherein enabling the secure communication comprises:
sharing and synchronizing data between the primary persona and the secondary persona.

8. The method as claimed in claim 6, wherein the secure bridge comprises a rule engine, a malware scanner, and an application register.

9. The method as claimed in claim 1, further comprising:
generating an integrity value for at least one of the primary operating system and the one or more secondary system during a booting process of the communication device, wherein the integrity value is used to disable an access to protected data and provide the access based on a match of the integrity value.

10. A system providing a secure communication between multiple operators in a communication device, the system comprising:
a processor;
a memory coupled to the processor, wherein the memory stores a plurality of modules to be executed by the processor, wherein the plurality of modules are configured to:
load a primary operating system;
performing through the primary operating system, an authentication check of one or more secondary operating systems in the communication device, wherein the one or more secondary operating systems are authenticated based on rule assignation; and
enabling a secure communication between the one or more secondary operating systems after the authentication.

11. The system as claimed in claim 10, wherein the primary operating system may comprise a secure operating system, and wherein the secure operating system is a memory curtailed read only operating system.

12. The system as claimed in claim 10, wherein the one or more secondary operating system comprise a personal operating system and a protected operating system, wherein the personal operating system comprises personal data, applications, games, personal calendar, photos, videos, music, and wherein the protected operating system comprises enterprise data, banking applications, enterprise environment.

13. The system as claimed in claim 10, wherein the personal operating system and the protected operating system are created by a hypervisor.

14. The system as claimed in claim 10, wherein the secured operating system comprises a secured operating system code, a secured communication rules, and private cryptographic keys, wherein the private cryptographic keys are configured to authenticate the personal operating system and the protected operating system.

15. The system as claimed in claim 14, wherein the secured communication rules comprises rules related to communication between the personal operating system and the protected operating system, wherein the secured communication rules specify scanning mechanisms to define data sharing between the personal operating system and the protected operating system.

16. The system as claimed in claim 10, wherein the plurality of modules are further configured to:
receive a data transfer request command by the primary operating system from the one or more secondary operating systems;
check an existence of rule corresponding to the data request command with at least one request authentication rule;
allowing the transfer of the data between the one or more secondary operating systems based on the checking.

17. The system as claimed in claim 10, wherein the primary operating system is configured to protect password screen from anti-phishing attack by saving anti-phishing data in the primary operating system, wherein the password is further protected by authenticating mobile application requesting for password while sharing anti-phishing data.

18. The system as claimed in claim 10, wherein the plurality of modules are further configured to:
create multiple personas for the communication device, wherein the multiple personas comprises a primary persona and a secondary persona; and
enable a secure communication between multiple personas through a secure bridge.

19. The system as claimed in claim 18, wherein enabling the secure communication comprises:
sharing and synchronizing data between the primary persona and the secondary persona.

20. The system as claimed in claim 18, wherein the secure bridge comprises a rule engine, a malware scanner, and an application register.

21. The system as claimed in claim 10, wherein the plurality of modules are further configured to:
generate an integrity value for at least one of the primary operating system and the one or more secondary system during a booting process of the communication device, wherein the integrity value is used to disable an access to protected data and provide the access based on a match of the integrity value.
